(19) United States
(12) Patent Application Publication
(10) Pub. No.: US 2025/0262577 A1
(43) Pub. Date: Aug. 21, 2025

(54) SCREENING DEVICE

(71) Applicant: HUBER SE, Berching (DE)

(72) Inventor: Andreas Beck, Neumarkt (DE)

(21) Appl. No.: 19/056,399

(22) Filed: Feb. 18, 2025

(30) Foreign Application Priority Data
Feb. 20, 2024 (DE) 10 2024 104 656.2

(51) Int. Cl. B01D 33/333; B01D 33/76; C02F 1/00

(52) U.S. Cl. CPC B01D 33/333; B01D 33/76; C02F 1/001

(57) ABSTRACT

A screening device for removing impurities and aquatic life from flowing wastewater includes: multiple screening elements adjacently arranged along a movement direction and forming a continuously rotating filter belt; an upper deflection mechanism and a lower deflection mechanism, by means of which the continuous filter belt is deflected; at least one first collection device for the impurities; and at least one separate second collection device for the aquatic life, wherein the upper deflection mechanism includes a deflection element, and wherein at least a portion of the at least one first collection device is located in the region of the deflection element and/or underneath the deflection element along a vertical direction. The at least one first collection device and the at least one second collection device are adjacently arranged along a transverse direction.

### CROSS-REFERENCE TO RELATED APPLICATIONS

The present application is based upon and claims the right of priority to German Patent Application No. 10 2024 104 656.2, filed Feb. 20, 2024, the disclosure of which is hereby incorporated by reference herein in its entirety for all purposes.

### FIELD OF THE INVENTION

The present subject matter relates to a screening device for removing impurities and aquatic life from flowing wastewater, which screening device has multiple screening elements that are adjacently arranged along a movement direction and form a continuously rotating filter belt; an upper deflection mechanism and a lower deflection mechanism, by means of which the continuous filter belt is deflected such that the screening elements are moved upwards in a vertical direction on a first side of the screening device and the screening elements are moved downwards counter to the vertical direction on a second side of the screening device when the screening device is used as intended; at least one first collection device for the impurities; and at least one separate second collection device for the aquatic life, wherein the upper deflection mechanism includes a deflection element by means of which the continuous filter belt is picked up on the first side of the screening device and deflected towards the second side of the screening device when the screening device is used as intended, and wherein at least a portion of the at least one first collection device is located in the region of the deflection element and/or underneath the deflection element along the vertical direction.

### BACKGROUND OF THE INVENTION

U.S. Pat. No. 4,199,453 A describes a device for protecting aquatic life carried by the wastewater passing through a vertical moving filter belt unit having inwardly opening screen baskets. The device includes a discharge trough for the aquatic life and a main discharge trough for the impurities, wherein these are located one above the other, or overlap. It is disadvantageous that impurities very easily enter the discharge trough along with the aquatic life, and that additional means are required to prevent this from happening. A sufficient separation of the aquatic life and the impurities cannot be ensured. It is also possible that the aquatic life is injured by the impurities in this process. Similarly, it is not ensured by the device disclosed in such prior patent that the aquatic life is guided into the discharge trough or is guided past the discharge trough.

Accordingly, a need exists for eliminating the disadvantages known from the prior art. Specifically, a need exists for providing a screening device which, when used, enables the aquatic life to be discharged in a protected and efficient manner. Additionally or alternatively, a need exists for achieving the discharge and/or the collection of the aquatic life using a very small chamber opening, in particular using the smallest chamber opening and/or of simplifying the production of the screening device.

### SUMMARY OF THE INVENTION

In various aspects, the problem(s) of the prior art are addressed by a screening device having the features described and claimed herein. Advantageous or preferred embodiments or developments of the present subject matter are characterized by the features described and claimed herein.

In one aspect, the present subject matter relates to a screening device for removing impurities, in particular solids and aquatic life, in particular fish, from flowing wastewater. Such screening devices can also be referred to as belt screens or a filter belt machine. Preferably, the wastewater flows through the screening device from the inside to the outside.

The screening device preferably has multiple screening elements that are adjacently arranged along a movement direction and form a continuously rotating filter belt. The screening elements can also be referred to as filter elements. When the screening device is used as intended, the wastewater flows through the screening elements and, in the process, the impurities and the aquatic life are retained. Due to a rotating movement of the continuous filter belt along the movement direction, the impurities and the aquatic life are conveyed upwards. Due to the continuous filter belt, it is ensured that the wastewater always flows through one of the multiple screening elements.

The screening device preferably includes an upper deflection mechanism and a lower deflection mechanism, by means of which the continuous filter belt is deflected such that the screening elements are moved upwards in a vertical direction on a first side of the screening device and the screening elements are moved downwards counter to the vertical direction on a second side of the screening device when the screening device is used as intended. As described above, the movement takes place along the movement direction.

The screening device preferable includes at least one first collection device for the impurities. The screening device preferably includes at least one separate second collection device for the aquatic life. The at least one first collection device and the at least one second collection device are preferably arranged in the region of the upper deflection mechanism, or underneath the upper deflection mechanism. Thus, the impurities and/or the aquatic life can be conveyed, in particular dropped and/or rinsed, into the at least one first collection device and/or into the at least one second collection device. The at least one first collection device can also be referred to as a trash collection device. The at least one second collection device can be referred to as an aquatic life collection device or as a fish collection device.

The upper deflection mechanism preferably includes a deflection element by means of which the continuous filter belt is picked up on the first side of the screening device and deflected towards the second side of the screening device when the screening device is used as intended. The deflection element is preferably arranged on an inner side of the continuous filter belt.

Preferably, at least a portion of the at least one first collection device is located in the region of the deflection element and/or underneath the deflection element along the vertical direction.

Preferably, the at least one first collection device and the at least one second collection device are adjacently arranged along a transverse direction. Preferably, at least a portion of the at least one first collection device and of the at least one second collection device are located in the region of the deflection element and/or underneath the deflection element along the vertical direction.

Due to the fact that the at least one first collection device and the at least one second collection device are adjacently situated along the transverse direction, the impurities and the aquatic life can be easily separated from one another and the particular collection device can be emptied. In the region of the upper deflection mechanism, in particular at the uppermost point of the screening device, the movement direction extends at least partially along the transverse direction. If the impurities and the aquatic life are separated from the screening element in succession in the region of the upper deflection mechanism, it is possible to capture these in a corresponding manner using the particular collection device.

Due to the fact that the at least one first collection device is arranged in the region of the deflection element and the at least one second collection device is arranged next to the first collection device along the transverse direction, a chamber opening that is as small as possible can be realized. A chamber opening is understood to mean the overall size of the screening device along the transverse direction. The chamber opening is therefore substantially the distance from the first side of the screening device to the second side or the distance between two screening elements arranged on different sides of the screening device. The arrangement according to the present subject matter therefore makes it possible to achieve the discharge and/or the collection of the impurities and the aquatic life using a very small chamber opening.

A further deflection mechanism and thus an enlarged chamber opening are therefore not absolutely necessary to effectively protect the aquatic life. The first collection device and the second collection device can also be designed the same or as an identical part when the chamber openings are different. This reduces the production costs to produce multiple screening devices of different overall sizes.

It is advantageous when the at least one first collection device and the at least one second collection device are at least partially interconnected. It can therefore be advantageous when a first collection trough of the first collection device and a second collection trough of the second collection device adjoin each other and/or are interconnected and/or are formed as a one-piece collection unit. Additionally or alternatively, it can be advantageous when a first guide element of the first collection device and a second guide element of the second collection device together form a guide unit. This enables the number of components of the screening device to be reduced and/or the assembly of the screening device to be simplified.

It is also advantageous when the upper deflection mechanism has at least one further deflection element, which said at least one further deflection element is arranged downstream from the deflection element along the movement direction, such that the continuous filter belt is taken over from the deflection element and released on the second side when the screening device is used as intended. By means of the further deflection element, the chamber opening of the screening device can be enlarged.

It is advantageous when the first collection device has at least one first opening and/or at least one first guide element and/or at least one first collection trough. The first opening is understood to mean the opening of the at least one first collection device. By means of the at least one first opening, the impurities can be introduced into the first collection trough. By means of the first collection trough, the impurities can be carried away, in particular transported out of the screening device. The at least one first opening is preferably directed upwards, such that the impurities can drop from above along the vertical direction into the first collection trough. By means of the at least one first guide element, the impurities can be guided and/or directed to the first opening and/or to the first collection trough.

It is also advantageous when the second collection device has at least one second opening and/or at least one second guide element and/or at least one second collection trough. The second opening is understood to mean the opening of the at least one second collection device. By means of the at least one second opening, the aquatic life can be introduced into the second collection trough. By means of the second collection trough, the aquatic life can be carried away, in particular transported out of the screening device. The at least one second opening is preferably directed upwards, such that the aquatic life can drop from above along the vertical direction into the second collection trough. By means of the at least one second guide element, the aquatic life can be guided and/or directed to the second opening and/or to the second collection trough. By means of the at least one second guide element and/or the at least one second collection trough, the fall height for the aquatic life can be reduced. Thus, injuries can be minimized.

It is additionally advantageous when at least a portion of the at least one first collection device, in particular the first opening and/or the first guide element, and at least a portion of the at least one second collection device, in particular the second opening and/or the second guide element, are located in the region of the deflection element and/or along the vertical direction underneath the deflection element.

It is additionally advantageous when the at least one first collection device and the at least one second collection device and/or the at least one first guide element and the at least one second guide element adjoin each other along the transverse direction. In this way, a design that is as compact as possible is achievable. Additionally or alternatively, as a result, a gap can be prevented from forming between the first collection device and the second collection device, through which gap aquatic life and/or impurities can drop.

Moreover, it is advantageous when the first guide element and the second guide element together form a guide unit, which guide unit is preferably roof-shaped. The first guide element and the second guide element each form one roof surface. The first guide element and the second guide element are preferably adjacently arranged at a ridge of the roof-shaped guide unit. Additionally or alternatively, the fall height for the aquatic life can be further reduced as a result. The guide unit is preferably arranged along the vertical direction above the first collection trough, the second collection trough, the first opening, and/or the second opening. By means of the above-described development using the guide unit, the separation of the impurities and the aquatic life can also be improved. In particular, it can be ensured via the guide unit that the aquatic life and/or the impurities are directed either to the first collection trough by means of the first guide element or to the second collection trough by means of the second guide element.

It is also advantageous when the first guide element, the second guide element, and/or the guide unit are arranged along the vertical direction above the first opening and the second opening. In this way, the fall height, in particular for the aquatic life, can be reduced. Additionally or alternatively, the first collection trough and/or the second collection trough can have a greater distance to the continuous filter belt along the vertical direction. In this way, the design freedom can be ensured while simultaneously providing a high level of protection for the aquatic life.

It is also advantageous when the deflection element is in the form of at least one deflection wheel and/or the at least one further deflection element is in the form of a deflection profile, in particular a deflection runner. The deflection element which is in the form of a deflection wheel is preferably in the form of a sprocket and/or includes at least one sprocket. The deflection element can preferably include at least one sprocket and/or two sprockets. By means of the at least one sprocket, the deflection element can be engaged with and/or rotate along with the continuous filter belt. Additionally or alternatively, it is possible that the continuous filter belt is driven by means of the sprocket.

The further deflection element, which is in the form of a deflection profile, stands still during deflection, and the continuous filter belt is deflected by the further deflection element by means of sliding friction. Due to the fact that the further deflection element is located downstream from the deflection element along the movement direction, a lower amount of wear is ensured than is the case for the further deflection element in the form of a deflection runner or a deflection track or a deflection profile since a lower load from the continuous filter belt acts on the further deflection element in this case. In this way, the friction, in particular the sliding friction, which acts from the continuous filter belt on the further deflection element as the non-rotating deflection element can be reduced. Preferably, the further deflection element is arcuate and/or semi-circular. As a result, the sliding friction can be further reduced.

Moreover, it is advantageous when the deflection element and the further deflection element are spaced apart from one another and/or an intermediate space is located between the deflection element and the further deflection element. The intermediate space is understood to mean the region of the screening device located between the deflection element and the further deflection element. At one end of the intermediate space, the continuous filter belt extends tangentially to the deflection element. At another end of the intermediate space, the continuous filter belt extends tangentially to the further deflection element.

In addition, it is advantageous when at least a portion of the at least one first collection device and/or at least a portion of the at least one second collection device is located in the region of the intermediate space and/or underneath the continuous filter belt in the region of the intermediate space. As a result, by means of the cleaning unit, the continuous filter belt can be cleaned prior to reaching the further deflection element and/or the impurities and/or the aquatic life can be collected by means of the at least one first collection device and/or the at least one second collection device. As a result, the impurities and/or the aquatic life are prevented from being transported back into the wastewater by the continuous filter belt counter to the vertical direction.

It is advantageous when the screening device includes at least one cleaning unit for cleaning the screening elements, which cleaning unit is preferably associated with the upper deflection mechanism, in particular the deflection element and/or the intermediate space. By means of the cleaning unit, the screening elements can be cleaned of the impurities from the wastewater. Additionally or alternatively, the cleaning unit can act on the aquatic life, in particular in a gentle manner, such that the aquatic life is rinsed off the screening elements.

It is also advantageous when the screening elements and/or the continuous filter belt include at least one collection recess for the aquatic life. The aquatic life can be collected in the collection recesses. Thus, it is possible to move the aquatic life in a gentle manner along with the screening element by means of the collection recesses and transport the aquatic life to the second collection device.

It is also advantageous when the cleaning unit includes at least one high-pressure nozzle for cleaning the screening elements of the impurities and/or at least one low-pressure nozzle for rinsing the aquatic life off the screening elements and/or out of the at least one collection recess. As is suggested by the names, the high-pressure nozzle is designed to output a fluid, in particular a liquid, preferably water, with a high pressure. The low-pressure nozzle is designed to output a fluid, in particular a liquid, preferably water, with a low pressure. The high-pressure nozzle acts on the screening elements in such a way that the impurities can be removed. During the action of the high-pressure nozzle, the aquatic life is preferably protected by the collection recess and/or has already been collected by the second collection device. By means of the low-pressure nozzle, the aquatic life can be transported from the screening element in a gentle manner, in particular out of the collection recess to the second collection device.

It is also advantageous when at least one of the screening elements includes at least one joint, in particular a rotary joint, by means of which the at least one collection recess can be at least partially rotated and/or at least partially opened in order to remove the aquatic life. This can facilitate the transport of the aquatic life to the second collection device and/or replace the low-pressure nozzle.

It is also advantageous when the at least one collection recess is designed such that the aquatic life is protected against the at least one cleaning unit, in particular the at least one high-pressure nozzle.

It is also advantageous when a first deflection region of the deflection element and a second deflection region of the further deflection element are operatively connected to the continuous filter belt, which second deflection region preferably follows the first deflection region along the movement direction of the continuous filter belt.

It is also advantageous when the at least one high-pressure nozzle and/or the at least one low-pressure nozzle is arranged such that this acts on one of the screening elements and/or on the at least one collection recess in the region of the deflection element and/or the first deflection region when the screening device is used as intended.

### BRIEF DESCRIPTION OF THE FIGURES

Further advantages of the invention are described in the following exemplary embodiments.

FIG. 1 shows a schematic side view of a screening device according to one exemplary embodiment,

FIG. 2 shows a portion of a schematic side view of a screening device according to an alternative exemplary embodiment, and

FIG. 3 shows a portion of a schematic side view of a screening device according to another exemplary embodiment.

### DETAILED DESCRIPTION

In the following description of the figures, the same reference characters are used for features that are identical and/or at least comparable in each of the various figures. The individual features, the embodiment and/or the mode of operation thereof are explained in detail usually only in the first mention thereof. If individual features are not explained in detail once more, the embodiment and/or the mode of operation thereof corresponds to the embodiment and the mode of operation of the previously described features having the same function or the same name.

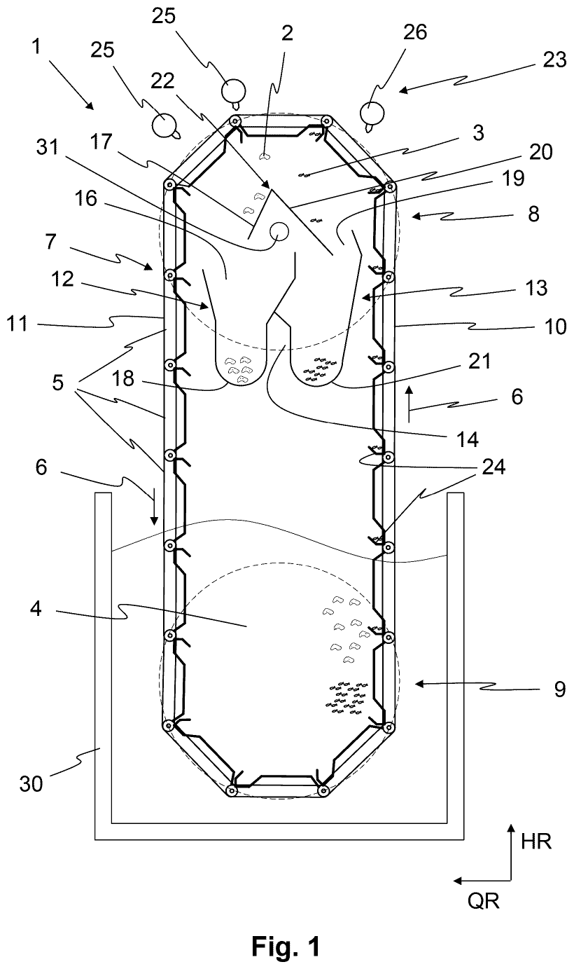

FIG. 1 shows a schematic side view of a screening device 1 according to one exemplary embodiment. The screening device 1 is designed to remove impurities 2 and aquatic life 3 from flowing wastewater 4. By way of example, the screening device 1 in the exemplary embodiment shown in FIG. 1 is in the form of a filter belt machine. The screening device 1 is schematically shown in FIG. 1 for greater clarity. Only some of the features and/or elements that are repeatedly present in the screening device 1 were provided with reference characters. Features and/or elements that do not have a reference character in FIG. 1 preferably correspond to the features and/or elements which have a similar design and have reference characters.

The screening device 1 includes multiple screening elements 5, which are adjacently arranged along a movement direction 6. The adjacently arranged screening elements 5 form a continuously rotating filter belt 7. An upper deflection mechanism 8 and a lower deflection mechanism 9 of the screening device 1 deflect the continuous filter belt 7 when the screening device 1 is used as intended, such that the screening elements 5 are moved upwards in a vertical direction HR on a first side 10 of the screening device 1 and the screening elements 5 are moved downwards counter to the vertical direction HR on a second side 11 of the screening device 1. When the screening device 1 is used as intended, the continuous filter belt 7 plunges into the wastewater 4 in the region of the lower deflection mechanism 9 and wastewater 4 preferably flows through the continuous filter belt from the inside toward the outside. As a result, it is possible that the impurities 2 and/or the aquatic life 3 are retained and/or removed by means of the screening elements 5.

In the exemplary embodiment shown in FIG. 1, the lower deflection mechanism 9 of the screening device 1 is located in a sewer 30. The sewer 30 can transport the wastewater 4 along the normal direction of the drawing sheet. It is similarly conceivable, however, that the screening device 1 is located in the sewer 30 such that the screening device has been rotated about a vertical axis. Additionally or alternatively, it is conceivable that the screening device 1 is located in an oblique sewer 30. Additionally or alternatively, the screening device 1 can be inclined with respect to the vertical axis. In the exemplary embodiment shown in FIG. 1, the non-clarified wastewater 4 is located inside the continuous filter belt 7 of the screening device 1. Wastewater flows through the screening elements 5 of the continuous filter belt 7 from the inside toward the outside.

The clarified and/or screened wastewater 4 is located outside of the continuous filter belt 7 of the screening device 1. The impurities 2 and/or the aquatic life 3 do not reach the outer side, but rather are retained by the screening elements 5. In order to ensure a constant flow through the screening elements 5, the screening elements move along the movement direction 6 when the screening device 1 is used as intended. In this way, flowing wastewater 4 flows through all screening elements 5 in alternation.

The upper deflection mechanism 8 includes a deflection element 14 by means of which the continuous filter belt 7 is picked up on the first side 10 of the screening device 1 and deflected towards the second side 11 of the screening device 1 when the screening device 1 is used as intended. In order to drive the continuous filter belt 7 along the movement direction 6, the screening device 1 includes a drive device 31 in the exemplary embodiment shown in FIG. 1. The drive device 31 acts on the upper deflection mechanism 8, in particular on the deflection element 14, in the exemplary embodiment shown. The deflection element 14 of the upper deflection mechanism 8 is preferably in the form of a sprocket which can drive the continuous filter belt 7. For example, the drive device 31 includes a drive motor.

As the flow through the screening elements 5 increases, the impurities 2 and/or the aquatic life 3 are deposited on the screening elements 5 through which the wastewater 4 flows. As the deposition increases, the flow through the particular screening element 5 is reduced and/or the pressure in the interior of the continuous filter belt 7 increases and/or the water level inside the sewer 30 increases. For example, the screening device 1 can detect this and moves the continuous filter belt 7 further along the movement direction 6. The wastewater then flows through another of the multiple screening elements 5.

In order to clean the screening elements 5 and/or the continuous filter belt 7, the screening device 1 includes at least one cleaning unit 23. The at least one cleaning unit 23 is associated with the upper deflection mechanism 8 in the exemplary embodiment shown in FIG. 1. Additionally or alternatively, it is conceivable that the cleaning unit 23 is associated with the first side 10 and/or the second side 11 of the screening device 1.

The at least one cleaning unit 23 includes, in the exemplary embodiment shown in FIG. 1, a high-pressure nozzle 25 for the impurities 2 and at least one low-pressure nozzle 26 for the aquatic life 3. It is similarly conceivable that the cleaning unit 23 includes only the high-pressure nozzle 25 or the low-pressure nozzle 26 and/or other means for cleaning. For example, the at least one high-pressure nozzle 25 and/or the at least one low-pressure nozzle 26, as depicted in the exemplary embodiment shown in FIG. 1, can act on the screening elements 5 from the outside. It is similarly conceivable that the cleaning unit 23 includes multiple high-pressure nozzles 25 and/or multiple low-pressure nozzles 26. When the cleaning unit 23 is used as intended, liquid can act on the screening elements 5 with high pressure by means of the high-pressure nozzle 25 and/or with low pressure by means of the low-pressure nozzle 26.

The screening device 1 includes at least one first collection device 12 for the impurities 2 and at least one separate second collection device 13 for the aquatic life 3. In the exemplary embodiment shown in FIG. 1, at least a portion of the at least one first collection device 12 is located in the region of the deflection element 14. It is also conceivable that the at least one first collection device 12 is located underneath the deflection element 14 along the vertical direction HR. The second collection device 13 and the first collection device 12 are adjacently situated along a transverse direction QR of the screening device 1. The at least one first collection device 12 and the at least one second collection device 13 can be independent of one another and/or separably interconnected.

In the exemplary embodiment shown in FIG. 1, the second collection device 13 is located closer to the first side 10, or adjacent to the first side 10, of the screening device 1. The first collection device 12 is located closer to the second side 11, or adjacent to the second side 11, of the screening device 1. As a result, it is possible that initially the aquatic life 3 is transported from the screening elements 5 into the second collection device 13. Only afterwards are the impurities 2 transported from the screening elements 5 into the first collection device 12. The at least one low-pressure nozzle 26 is arranged such that it assists in depositing the aquatic life 3 into the second collection device 13. The at least one high-pressure nozzle 25, specifically the two high-pressure nozzles 25 in the exemplary embodiment shown in FIG. 1, is/are arranged such that the high-pressure nozzle(s) assist(s) in depositing the impurities 2 into the first collection device 12. Thus, the at least one high-pressure nozzle 25 or the two high-pressure nozzles 25 is/are located downstream from the low-pressure nozzle 26 along the movement direction 6.

In order to protect the aquatic life 3, each of the screening elements 5 has a collection recess 24. The aquatic life 3 can be collected in the particular collection recess 24. The collection recess 24 can be designed such that the aquatic life 3 is transported from the wastewater 4 into the second collection device 13 in a manner which is gentle and/or protected from the cleaning unit 23. In the exemplary embodiment shown in FIG. 1, the collection recess 24 is in the form of a collection scoop on the screening elements 5. When the continuous filter belt 7 is deflected in the region of the upper deflection mechanism 8, the aquatic life 3 can drop into the second collection device 13 by gravity and/or assisted by the low-pressure nozzle 26.

The first collection device 12 includes, in the exemplary embodiment shown in FIG. 1, at least one first opening 16, at least one first guide element 17, and at least one first collection trough 18. By means of the first guide element 17, the impurities 2 can be transported to the at least one first opening 16. The at least one first collection trough 18 transports the impurities 2 away. The second collection device 13 includes, in the exemplary embodiment shown in FIG. 1, at least one second opening 19, at least one second guide element 20, and at least one second collection trough 21. By means of the second guide element 20, the aquatic life 3 can be transported to the at least one second opening 19. The at least one second collection trough 21 subsequently transports the aquatic life 3 away.

The at least one first guide element 17 and the at least one second guide element 20 jointly form a guide unit 22. By means of the guide unit 22, the aquatic life 3 can be deflected to the first side 10 of the screening device 1 and the impurities 2 can be deflected to the second side 11 of the screening device 1. The guide unit 22 in the exemplary embodiment shown in FIG. 1 is roof-shaped. By means of the guide unit 22, or of the second guide element 20, the fall height of the aquatic life 3 can be reduced, such that the aquatic life can be transported away in a gentle manner.

As is apparent, the first collection device 12 and the second collection device 13 in the exemplary embodiment shown in FIG. 1 are located in the region of the deflection element 14. The first collection trough 18 and the second collection trough 21, on the other hand, are located underneath the deflection element 14 along the vertical direction HR. The first guide element 17, the second guide element 20, and/or the guide unit 22 are located along the vertical direction HR above the first opening 16 and the second opening 19. Additionally or alternatively, it is conceivable that the first collection device 12 and/or the second collection device 13 is located at least partially and/or completely in the region of and/or underneath the deflection element 14.

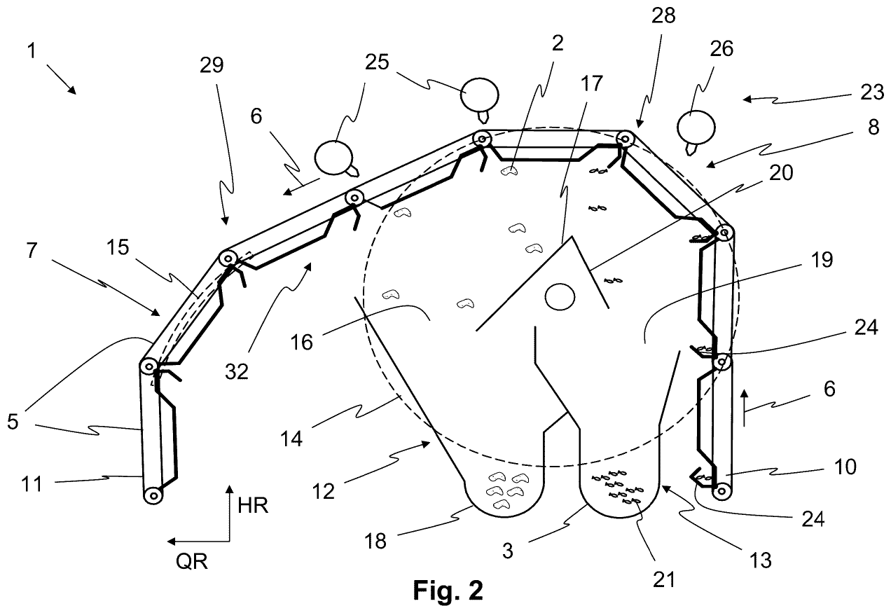

FIG. 2 shows a portion of a schematic side view of a screening device 1 according to an alternative exemplary embodiment. In this case as well, the screening device 1 is designed to remove impurities 2 and aquatic life 3 from flowing wastewater 4, similar to the embodiment of FIG. 1. The screening device 1 is schematically shown in FIG. 2 as well for greater clarity, similar to the view of FIG. 1. Only some of the features and/or elements that are repeatedly present in the screening device 1 were provided with reference characters. In addition, in the exemplary embodiment shown in FIG. 2, only the region of the upper deflection mechanism 8 is shown. The lower deflection mechanism 9, the wastewater 4, and/or the sewer 30 can be designed in accordance with the exemplary embodiment shown in FIG. 1.

In contrast to the exemplary embodiment shown in FIG. 1, the screening device 1 of the exemplary embodiment shown in FIG. 2 includes one further deflection element 15. The further deflection element 15 is located downstream from the deflection element 14 along the movement direction 6 in the exemplary embodiment shown in FIG. 2. The continuous filter belt 7 is taken over from the deflection element 14 and released on the second side 11 by means of the further deflection element 15 when the screening device 1 is used as intended. Therefore, the screening device 1 includes a first deflection region 28 which is formed by the deflection element 14 and a second deflection region 29 which is formed by the further deflection element 15. The further deflection element 15 is in the form of a deflection profile, in particular a deflection runner, in the exemplary embodiment shown in FIG. 1. Preferably, the further deflection element 15 is arcuate and/or semi-circular.

The deflection element 14 and the further deflection element 15 are spaced apart from one another, such that an intermediate space 32 is located between the deflection element 14 and the further deflection element 15. In the intermediate space 32, the continuous filter belt 7 extends substantially in a straight line. At both ends of the intermediate space 32, the continuous filter belt 7 transitions preferably tangentially into the deflection element 14 and the further deflection element 15. At least one collection device 12, 13 can be associated with the intermediate space 32 or located in the region of the intermediate space 32. In the present exemplary embodiment, the at least one first collection device 12 is located in the region of the intermediate space 32, in particular underneath the continuous filter belt 7 which is located in the intermediate space 32. Thus, impurities 12 in the region of the intermediate space 32 can also be collected by the at least one first collection device 12.

The cleaning unit 23, in particular the at least one high-pressure nozzle 25 and/or the at least one low-pressure nozzle 26, is associated with the first deflection region 28 and/or the intermediate space 32 in the exemplary embodiment shown in FIG. 2. In detail, the at least one low-pressure nozzle 26 in the exemplary embodiment shown in FIG. 2 is associated with the first deflection region 28, or is located in the region of the deflection element 14. One of the high-pressure nozzles 25 is also associated with the first deflection region 28, or is located in the region of the deflection element 14. In addition, in the exemplary embodiment shown in FIG. 2, one of the illustrated high-pressure nozzles 25 is associated with the intermediate space 32, such that the impurities 2 on the continuous filter belt 7 can also be cleaned off in the region of the intermediate space 32. As described above, it can be ensured as a result that the impurities 2 have been removed from the screening elements 5 along the movement direction 6 and, at the latest, in the region of the intermediate space 32. In this way, the screening elements 5 can be deflected in the cleanest possible state by the further deflection element 15 and moved toward the wastewater 4 (see FIG. 1).

As a result, it is possible to position the first collection device 12 as well as the second collection device 13 in the region of the deflection element 14 and the intermediate space 32. In this way, it can be ensured that the impurities 2 have been at least largely cleaned off the continuous filter belt 7 before the continuous filter belt 7 has reached the further deflection element 15. The deflection element 14 is in the form of a rotating deflection mechanism. The further deflection element 15 is in the form of a non-rotating and/or spatially fixed deflection mechanism.

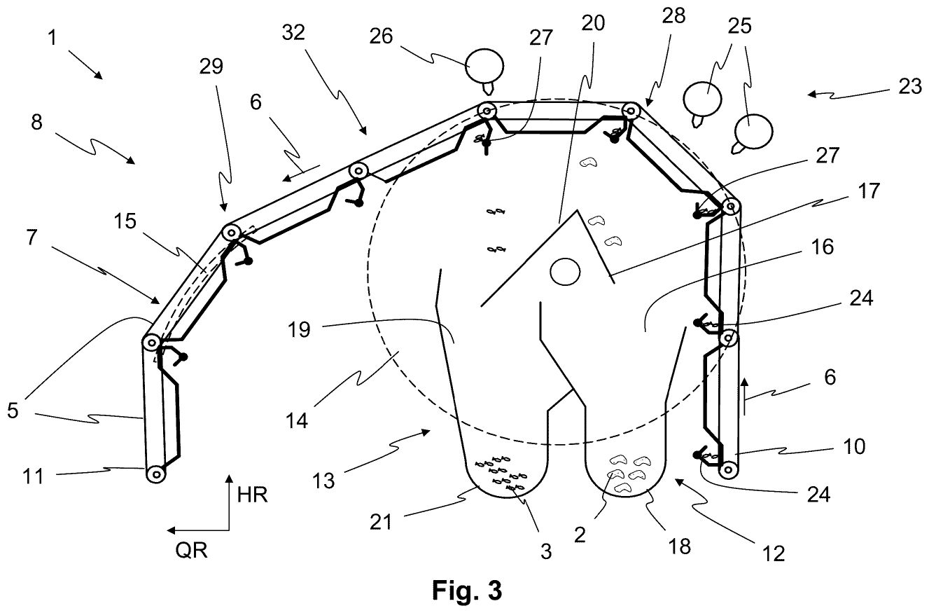

FIG. 3 shows a portion of a schematic side view of a screening device 1 according to another exemplary embodiment. In this case as well, the screening device 1 is shown merely schematically, similar to the preceding exemplary embodiments. Similar to the screening device 1 of the exemplary embodiment shown in FIG. 2, in the screening device 1 of the exemplary embodiment shown in FIG. 3, the lower deflection mechanism 9, the wastewater 4, and/or the sewer 30 can be designed in accordance with the exemplary embodiment shown in FIG. 1.

The exemplary embodiment shown in FIG. 3 differs inter alia in the arrangement of the at least one first collection device 12 and of the at least one second collection device 13 in comparison with the screening devices 1 in the exemplary embodiments shown in FIGS. 1 and 2. In the exemplary embodiment shown in FIG. 3, the at least one first collection device 12 is located closer to the first side 10 of the screening device 1, or is associated with the first side 10. The at least one second collection device 13 is located correspondingly closer to the second side 11 of the screening device 1, or is associated with the second side 11. Thus, the impurities 2 are preferably first cleaned off the screening elements 5 and transported into the first collection device 12. To this end, the at least one high-pressure nozzle 25 first acts on the screening element 5 along the movement direction 6. Then, the aquatic life 3 is transported into the at least one second collection device 13, in particular by means of the low-pressure nozzle 26.

In addition, at least one of the screening elements 5 in the exemplary embodiment shown in FIG. 3 includes a joint 27, in particular a rotary joint, by means of which the collection recess 24 can be at least partially rotated and/or at least partially opened in order to remove the aquatic life 3. In the exemplary embodiment shown in FIG. 3, one part of the collection recess 24 is rotated and, thus, the collection recess 24 is partially opened. As a result, it is possible that the aquatic life 3 in the exemplary embodiment shown in FIG. 3 initially remains in the collection recess 24 when the continuous filter belt 7 is deflected by means of the deflection element 14. By means of the joint 27, the first deflection region 28 can therefore be at least partially traversed before the aquatic life 3 drops out of the collection recess 24 along the vertical direction HR. By means of the joint 27, the aquatic life 3 can therefore be guided or conveyed out of the collection recess 24 in an active and controlled manner. The collection recess 24 and/or the joint 27 can additionally or alternatively protect the aquatic life 3 from the action of the high-pressure nozzle(s) 25.

It should be noted that the screening elements 5 in the exemplary embodiments shown in FIGS. 1 and 2 can also include corresponding joints 27. It is also possible that the screening devices 1 shown in FIGS. 2 and 3 include the upper deflection mechanism 8 with only the deflection element 14 and without the further deflection element 15.

### LIST OF REFERENCE CHARACTERS

1 screening device
2 impurity
3 aquatic life
4 wastewater
5 screening element
6 movement direction
7 continuous filter belt
8 upper deflection mechanism
9 lower deflection mechanism
10 first side
11 second side
12 first collection device
13 second collection device
14 deflection element
15 further deflection element
16 first opening
17 first guide element
18 first collection trough
19 second opening
20 second guide element
21 second collection trough
22 guide unit
23 cleaning unit
24 collection recess
25 high-pressure nozzle
26 low-pressure nozzle
27 joint
28 first deflection region
29 second deflection region
30 sewer
31 drive device
32 intermediate space
HR vertical direction
QR transverse direction

1-15. (canceled)

16. A screening device for removing impurities and aquatic life from flowing wastewater, the screening device comprising:
a plurality of screening elements adjacently arranged along a movement direction and forming a continuous filter belt;
an upper deflection mechanism and a lower deflection mechanism, the upper and lower deflection mechanisms configured to deflect the continuous filter belt such that the plurality of screening elements are moved upwards in a vertical direction on a first side of the screening device and the plurality of screening elements are moved downwards counter to the vertical direction on a second side of the screening device;
at least one first collection device for the impurities; and
at least one separate second collection device for the aquatic life,
wherein:
the upper deflection mechanism includes a deflection element configured such that the continuous filter belt is picked up on the first side of the screening device and deflected towards the second side of the screening device;
at least a portion of the at least one first collection device is located in a region of the deflection element and/or underneath the deflection element along the vertical direction; and
the at least one first collection device and the at least one second collection device are adjacently arranged along a transverse direction.

17. The screening device of claim 16, wherein the upper deflection mechanism includes at least one further deflection element that is located downstream from the deflection element along the movement direction such that the continuous filter belt moves from the deflection element to the at least one further deflection element and released on the second side of the screening device.

18. The screening device of claim 17, wherein the deflection element and the at least one further deflection element are spaced apart from one another and/or an intermediate space is located between the deflection element and the at least one further deflection element.

19. The screening device of claim 18, wherein the screening device includes at least one cleaning unit for cleaning the plurality of screening elements, the at least one cleaning unit being associated with the deflection element and/or with the intermediate space.

20. The screening device of claim 17, wherein a first deflection region of the deflection element and a second deflection region of the at least one further deflection element are operatively connected to the continuous filter belt, wherein the second deflection region follows the first deflection region along the movement direction of the continuous filter belt.

21. The screening device of claim 16, wherein the at least one first collection device has at least one first opening and/or at least one first guide element and/or at least one first collection trough.

22. The screening device of claim 16, wherein the at least one second collection device has at least one second opening and/or at least one second guide element and/or at least one second collection trough.

23. The screening device of claim 16, wherein the at least one first collection device has at least one first opening and at least one first guide element and wherein the at least one second collection device has at least one second opening and at least one second guide element, wherein at least a portion of the at least one first opening and/or the at least one first guide element the at least one first collection device and at least a portion of the at least one second opening and/or the at least one second guide element are located in the region of the deflection element and/or along the vertical direction underneath the deflection element.

24. The screening device of claim 16, wherein the at least one first collection device has at least one first guide element and wherein the at least one second collection device has at least one second guide element, wherein the at least one first collection device and the at least one second collection device and/or the at least one first guide element and the at least one second guide element adjoin each other along the transverse direction.

25. The screening device of claim 16, wherein the at least one first collection device has at least one first guide element and wherein the at least one second collection device has at least one second guide element, wherein the at least one first guide element and the at least one second guide element form a guide unit.

26. The screening device of claim 25, wherein the guide unit is roof-shaped.

27. The screening device of claim 25, wherein the at least one first collection device has at least one first opening and the at least one second collection device has at least one second opening, wherein the at least one first guide element, the at least one second guide element, and/or the guide unit are arranged along the vertical direction above the at least one first opening and the at least one second opening.

28. The screening device of claim 16, wherein the screening device includes at least one cleaning unit for cleaning the plurality of screening elements.

29. The screening device of claim 28, wherein the at least one cleaning unit includes at least one high-pressure nozzle for cleaning the impurities off the plurality of screening elements and/or at least one low-pressure nozzle for rinsing the aquatic life off the plurality of screening elements and/or out of at least one collection recess of the continuous filter belt.

30. The screening device of claim 16, wherein the continuous filter belt includes at least one collection recess for the aquatic life.

31. The screening device of claim 30, wherein the at least one collection recess is configured such that the aquatic life is protected against at least one cleaning unit of the screening device.

32. The screening device of claim 30, wherein at least one screening element of the plurality of screening elements has at least one joint, the at least one joint being configured to allow the at least one collection recess to be at least partially rotated and/or opened in order to remove the aquatic life.

33. The screening device of claim 30, wherein the screening device includes at least one cleaning unit for cleaning the plurality of screening elements, the at least one cleaning unit includes at least one high-pressure nozzle for cleaning the impurities off the plurality of screening elements and/or at least one low-pressure nozzle for rinsing the aquatic life off the plurality of screening elements and/or out of at least one collection recess of the continuous filter belt, wherein the at least one high-pressure nozzle and/or the at least one low-pressure nozzle is arranged to act on one of the plurality of screening elements and/or on the at least one collection recess in the region of the deflection element.
